(19) United States
(12) Patent Application Publication
(10) Pub. No.: US 2011/0302167 A1
(43) Pub. Date: Dec. 8, 2011

(54) Systems, Methods and Computer Program Products for Processing Accessory Information

(75) Inventors: Aditya Vailaya, San Jose, CA (US); Jiang Wu, Union City, CA (US); Jeffrey Ronne, Cupertino, CA (US)

(73) Assignee: RETREVO INC., Sunnyvale, CA (US)

(21) Appl. No.: 13/152,229

(22) Filed: Jun. 2, 2011

Related U.S. Application Data
(60) Provisional application No. 61/351,244, filed on Jun. 3, 2010.

(51) Int. Cl. G06F 17/30

(52) U.S. Cl. 707/737; 707/E17.089

(57) ABSTRACT

A computer-implemented method according to one embodiment includes, for each of a plurality of accessories: determining a compatibility of an accessory; determining a type of the accessory; and determining features of the accessory. The accessories are associated into logical groups based on the compatibility, type and features thereof. A computer-implemented method according to one embodiment includes obtaining information about accessories; parsing out individual offers corresponding to the accessories; extracting meaningful phrases from the offers; classifying new offers based on the phrases; and outputting a result of the classification. Additional systems, methods and computer program products are also presented.

### RELATED APPLICATIONS

This application claims priority to provisional U.S. Patent Appl. No. 61/351,244, filed Jun. 3, 2010, and which is herein incorporated by reference.

### SUMMARY

There are many accessory offers sold by large number of accessory manufacturers and sellers. Many of the accessories are inexpensive in relation to the core product they work for, hence most merchants sell accessories without creating much of a structured description or a set of features. In fact, many times merchants sell accessories with minimal description that may not even include an identity of the particular model that the accessory is compatible with, or they may not define a structured set of features of the accessory. Moreover, many accessories may be created for the same product and type of accessory (such as is typically the case for iPhone products) by the same or multiple manufacturers and there is no attempt to combine them into a single offering. Such large numbers of accessories can inundate the user and affect the final sale conversions. Moreover, the large number of accessories (running into millions of products with tens of thousands of new accessories coming to market on a daily basis) may preclude any attempt at manual classification and feature extraction. Therefore, there is strong need for automatically processing, grouping, and extracting features for accessories. Various embodiments of the present invention address the problem of extracting structured information from unstructured accessory information such that they can be properly classified, grouped, and easily navigated. In particular, computer-based methods are defined to extract compatible models (e.g., which product(s) does an accessory work for), type of accessory (e.g., is it a case, a screen protector, etc.), and features of the accessory (color, dimensions, power consumption, etc.).

A computer-implemented method according to one embodiment includes, for each of a plurality of accessories: determining a compatibility of an accessory; determining a type of the accessory; and determining features of the accessory. The accessories are associated into logical groups based on the compatibility, type and features thereof.

A computer program product embodied on a nontransitory computer readable medium, according to one embodiment includes: computer code for determining a compatibility of an accessory; computer code for determining a type of the accessory; computer code for determining features of the accessory; and computer code for associating the accessories into logical groups based on the compatibility, type and features thereof.

A system according to one embodiment includes logic for determining a compatibility of an accessory; logic for determining a type of the accessory; logic for determining features of the accessory; and logic for associating the accessories into logical groups based on the compatibility, type and features thereof.

A computer-implemented method according to one embodiment includes obtaining information about accessories; parsing out individual offers corresponding to the accessories; extracting meaningful phrases from the offers; classifying new offers based on the phrases; and outputting a result of the classification.

A computer-implemented training process according to one embodiment includes obtaining accessory offers; parsing the offers to extract information about the accessories described in the offers; determining compatibility information from the extracted information about the accessories; extracting phrases from the extracted information about the accessories; clustering the extracted phrases; generating type graphs, receiving user input for manually editing the type graphs; generating type rules; classifying the offers into particular accessory types based on the type rules; identifying features for the accessory types; generating parsers for feature extraction; extracting features from offers classified into the particular accessory types; and clustering the offers into offer groups based on compatibility, corresponding accessory types, and extracted features.

A computer-implemented production process according to one embodiment includes obtaining one or more accessory offers; parsing the one or more accessory offers to extract information about the accessories; determining compatibility information from the extracted information; extracting phrases from the information about the accessories; using the extracted phrases to classify the offers based on type rule definitions; extracting features from the offers classified into accessory types; and generating an offer signature based on one or more of compatibility, accessory types, and accessory features associated with the input accessory offer.

### BRIEF DESCRIPTION OF THE DRAWINGS

FIG. 1 is a conceptual model diagram that illustrates various illustrative components of accessory information, according to one embodiment.

FIG. 2 depicts a Logical Data Structure (LDS) that describes the data and the relationship that may be maintained by the accessory processing implementation according to one embodiment.

FIG. 3 is a high level process flow diagram depicting a process for processing offers according to one embodiment.

FIG. 4 depicts a process for accessory training, according to one embodiment.

FIG. 5 depicts a process for accessory production according to one embodiment.

FIG. 6 depicts an illustrative accessory offer.

FIG. 7 depicts a conceptual illustration of parsing of the illustrative accessory offer of FIG. 6.

FIG. 8 depicts an illustrative clustering graph that can be generated according to one embodiment.

FIG. 9 illustrates a table storing the association of accessory offers with one or more accessory types, according to one illustrative embodiment.

FIGS. 10-18 depict illustrative user interfaces in which the grouped accessory information may be output and optionally navigated.

FIG. 19 illustrates a network architecture, in accordance with one embodiment.

FIG. 20 shows a representative hardware environment associated with a user device, in accordance with one embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

While the following description may refer to specific entities, approaches, sites, etc., this has been done by way of example only.

Overview

In general, one embodiment of the present invention provides a way to process accessory information. An accessory is generally defined as a product that sells mainly as a secondary product to another primary product. For example, in the case of cell phones, accessories may include: cell phone batteries, cases, screen protectors, memory cables, chargers, etc. For laptop computers, accessories might include memory, power adapters, batteries, etc. For cameras, accessories may include lenses, cables, memory cards, tripods, etc.

There are many, many accessory manufacturers and sellers. However, no one has done a good job of organizing accessories, nor making it easy for a consumer to find a needed accessory, compare features and prices, etc. Moreover, some accessories for sale online have a minimal description that may not even include an identity of the particular model that the accessory is compatible with. In other cases, the offer may merely list compatible devices without further description.

Disclosed herein is methodology for handling large amounts of accessory data and using that data to generate organized, meaningful aspects which are meaningful to the user.

In one general approach, a computer-implemented process for processing accessory information includes, for one or preferably multiple accessories, determining a compatibility of the accessory, e.g., determining which particular primary product(s) or type of primary product(s) the accessory works with; determining a type of accessory; and optionally, determining features of the accessory. The accessory is then associated with a group based on the determined information. The process is preferably computer-implemented.

In one approach, the compatibility, accessory type, and/or features are extracted from text or data associated with or relating to the accessory, such as a description of the accessory on a webpage, a description in a feed from any source such as a partner or manufacturer, information derived from scanned product literature, etc. by a computerized process. Thus, the source information may be mined using the Internet, received from partners and processed to extract the information, etc.

In one approach, user interface navigation data for the logical groups of accessories may be generated based on values associated with one or more of the compatibility of accessories in logical groups, the type of accessories in logical groups, and the features of accessories in the logical groups. The user interface navigation data in one approach may be any type of data useful for logically presenting the logical groups and/or the accessories associated therewith to a user in a structured and understandable format. Several illustrative examples of such user interface navigation data, including illustrative user interface outputs, are presented below.

A signature for each of the accessories may be generated based on one or more of the compatibility of the accessory, the type of the accessory, the features of the accessory, a title of the accessory, a description of the accessory, etc. Such signature may in turn be used to classify the accessories into logical groups.

Moreover, while much of the description discusses classifying and organizing accessories, the methodology may be used to organize accessory offers, links to information about accessories, documents about accessories, etc. Thus, it should be understood that the various embodiments of the present invention include such alternate embodiments, as will be apparent to those skilled in the art upon reading the teachings herein.

Compatibility

The compatibility of the accessory with a primary product or products is determined. The compatibility may be as narrow as an association with a particular phone model or as broad as a compatibility with a VGA connector. For example, if the accessory is for a cell phone, which cell phone make does the accessory work with, and preferably with which particular model of the cell phone.

Several techniques may be used to determine the compatibility, one or more of which may be used in a given implementation. The compatibility may be determined by receiving manually-derived input, such as receiving user input indicating that the accessory is compatible with a product. The compatibility may also be determined from information in a feed from a partner. For example, the feed may include a textual notation that the accessory is compatible with a list of primary products. The compatibility may also be determined from information in an offer, e.g., on a web page. In some approaches, an extraction process may be performed on the feed or offer to recognize the accessory and the primary product, and make the association. Techniques disclosed in one or more pending patent applications to the same inventors may also be adapted for such use. See, infer cilia, U.S. patent application Ser. Nos. 11/737,660; 60/912,108; and 11/963,684, which are herein incorporated by reference.

A logical association of an accessory to a primary product may also be made using information derived from different sources. For example, if a first accessory having a part number is denoted in a feed as being compatible with Product A, and it has been determined that the same accessory part number is denoted in an offer as being compatible with Products A and B, then the first accessory can be associated with Products A and B, even though the feed did not indicate this.

The characteristics of the raw data in some approaches is that it is mainly a piece of plain text. In the case of mining data from a website such as YAHOO, CRAIGSLIST or EBAY, there are hundreds of thousands of accessories for sale, each with a different description, and none of them organized on the website except possibly at a very high level, e.g., electronics, used items, etc. Moreover, some descriptions may include the term “cable”, which could indicate that the accessory is a cable, has a cable, or works with a particular cable. Some embodiments of the present invention are able to take the raw data and discern compatibility, accessory type and/or accessory features. Once one or more of these is discerned, the accessories can be organized and/or grouped in a coherent and meaningful way for output, e.g., as a web page having accessories from multiple partners organized by compatibility with a primary product, and further organized by accessory type, and with a description of features of the accessories. Thus, a user may enter a search for accessories for a particular product, and the list of accessories is output in an organized manner.

Upon determining the compatibility of the accessory, the compatibility association may be stored in a database, table, etc.

Accessory Type

Traditionally, a keyword search for an accessory type on a website resulted in a return of any product having the keyword. For example, a search for a cable might have returned hundreds of hits including cables, devices with cables, cable adapters, devices with interfaces for cables, etc. Thus, it became difficult for a user to not only find a particular accessory, but to compare features and prices of the accessories of interest.

Accordingly, the type of accessory is also determined in one embodiment. For example, a determination can be made that the accessory is a cable rather than a device with a cable, or a battery rather than a battery charger. Note that some accessories be associated with more than one type.

Similar techniques as used to determine the compatibility may be used to determine the accessory type. In other approaches, the accessory may be associated with one or more of a plurality of known types. Heuristics may be employed to determine the type. For example, an accessory listed as a “power brick” may be associated with the more common type “power adapter” based on words found in the text associated with the accessory (e.g., “90 W” implies a power output), an analysis of synonyms, etc. Similarly, such heuristics can be used to eliminate other possible types. For example, assume the “power brick” might be a battery or power adapter. However, a reference to “AC” or “plug” in an offer for the power brick may be known to be associated with power adapters and not batteries, while in another offer for a battery “power brick,” the terms “mAh” and “Li ion” are known to be associated with batteries but not power adapters.

Upon determining the type of accessory, the type association may be stored in a database, table, etc.

Accessory Features

Features of the accessory may also be determined. For example, if the accessory is a battery, what kind of battery it is may be determined, e.g., AA, AAA, Lithium Ion, and/or what are the other features of the battery, e.g., what amperage, what voltage, etc. Preferably, the foregoing is performed automatically using a computer. Such computer may automatically extract all of these features and code them for use in the accessory processing. For example, all six feet cables are identified, all four feet cables are identified, all two feet cables are identified, whether the cables are male to male or male to female is determined, etc. This information may then be used in any combination to create various separate categories.

Upon determining the accessory features, the feature associations may be stored in a database, table, etc.

Accessory Grouping

The foregoing information, determined for several accessories, may be used to coherently associate the accessories into logical groups. For example, similar and/or comparable accessories may be grouped together into offer groups based on the accessories being compatible with a particular model of a primary product. The grouping can be further refined, e.g., by then sorting the accessories compatible with the primary product by accessory type, by feature set, etc. Moreover, a particular accessory can be associated with more than one group.

In one approach, identical and/or equivalent and/or similar products can be identified and grouped into a single category. The accessories may be different brands, from different sellers or have different price ranges, but may have similar features and compatibility. Thus, identical, equivalent or similar accessories from various vendors can be determined to be the same, equivalent or similar based on the extracted features and listed as a single category with a price range, and the user may be permitted to drill down into the details of the accessory group to select one for purchase, perhaps the least expensive one, the one that has free shipping, etc.

The accessories, now associated with particular groups, can be output in a logical and organized manner based on the grouping. For example, a web page of accessories for Mobile Phone A may be generated with groups of accessories listed thereon, such as batteries, chargers, cases, earphones, etc. The high level accessory types may be listed, and particular accessories or sub-types may be listed for each type. In one approach, the same accessory or equivalent accessories available from multiple vendors may be represented by a selectable icon or link that, upon receipt of selection thereof, results in output of more information about the various accessories such as vendor, link to vendor site, price, features, etc. At the higher level, a price range for the accessory or equivalent accessories may be presented in association with the selectable icon or link.

More illustrative information will now be set forth regarding various optional architectures and features with which the foregoing framework may or may not be implemented, per the desires of the designers or user. It should be strongly noted that the following information is set forth for illustrative purposes and should not be construed as limiting in any manner. Any of the following features may be optionally incorporated with or without the exclusion of other features described.

Illustrative Approach for Accessory Acquisition and Classification

Accessory and consumables data may be read in as a feed from one or multiple partners (e.g., vendors, companies, users, etc.) and classified into several dimensions such as compatible model, usage, accessory type, and accessory features. One illustrative process includes obtaining information about the accessories, e.g., by downloading an accessory feed, reading a table or database, receiving input from a user, etc.; parsing out the individual offers corresponding to the accessories; optionally extracting compatible models from the accessory offers; extracting meaningful phrases (e.g., representing usage, type and features of accessories, etc.) from the offers; classifying new offers based on the above dimensions; and outputting a result of the classification. The classified results may be used in the application server.

The various processing steps may be divided into two main areas: training and production. The following description describes an outline of illustrative steps in training and production process.

A list of preferred functional parameters that may be used by various embodiments for accessory processing include one or more of:
Create the list of partner data feed to be processed.
Store the accessory feed content locally to allow reuse without refetch.
Store parsed accessory offers locally to allow reuse without reparse.
Classify partner offer data into accessories and “other” (such as product offers).
Identify compatible models mentioned inside each accessory offer.
Identify meaningful phrases (representing accessory type, and features) from accessory offers grouped by model, family, vendor, or category of compatible models.
Classify each accessory offer into one or more accessory types.
Handles 1, 10, 20, 40 million or more accessory offers on a daily basis.
Reliable storage of the content.
Distributed process where individual steps can be restarted or redone independently.
Distributed process where multiple individuals can work at the same time.
Process does not impact production system.
Ability to synchronize and upload the crawled data to production.
Ability to refresh the downloaded content periodically.

Additional parameters may include one or more of:
Data management console to control the process
Management system to train and tweak the classifier
Data storage for production level fetching and analysis
Data storage for testing, QA, and algorithm training.

Conceptual Model:

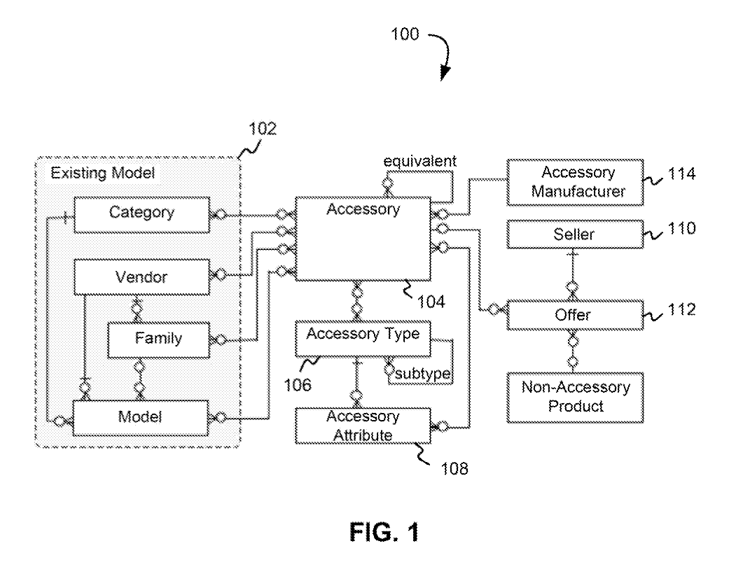

FIG. 1 is a conceptual model diagram 100 that illustrates various illustrative components of accessory information, according to one embodiment. Note that more, less, or other components may be used in various embodiments of the present invention. Various embodiments of the software, data, and processes disclosed herein may manage such a conceptual model.

The existing model area 102 in FIG. 1 represents a primary conceptual model for model, family and vendor. Extensions to the primary conceptual model may include:
Accessory (which may be a reusable item or consumable) 104—A product that sells mainly as a secondary product to another product. An accessory/consumable product, in most cases, does not make much sense without the key product (model) that it is designed for. For example, a battery for a camera, or ink for a printer. For simplicity, the present specification refers to both accessories and consumables as accessories. These data may be fetched or received from one or multiple data sources, may be entered by hand, etc.
Accessory Type 106—These are loosely defined in terms of the role an accessory plays.
Example of accessory types are: batteries, cases, tripods, flash, memory cards, ink, cartridge, etc. Each accessory offer is classified into one or more accessory types with different degree of confidence and various supporting data. Each accessory type may be relevant to several accessory offers such as a camera kit with battery, charger, and lens cleaners. An accessory type may be viewed as a subtype of another accessory type such as “wide-angle lens” is a subtype of “lens”.
Accessory Attribute 108—Loosely defined as the specifications of an accessory.
Examples include dimensions of a camera case, length of a cable, or color of printer ink. Accessory attributes may be extracted and used in classifying accessory offers. An attribute may be made of “Attribute Name” and “Attribute Value”. For each accessory type, there may be a well defined set of attribute names. Each offer of the accessory type may have different attribute values for the same attribute names.
Seller 110—A partner site or merchant site that is selling products. A seller may provide a feed having a list of products for sale (or offers). Example of sellers includes Amazon, eBay, etc. This may also include middlemen, wholesalers, distributors, etc.
Offer 112—an offer is a product listing that contains one or more of title, description, price, image, merchant URL, specifications, reviews, link to purchase, add to cart button, etc. An offer can be for an accessory or other (such as models).
Accessory Manufacturer 114—manufacturer of the accessory. This may also include middlemen, wholesalers, distributors, etc. This information may or may not be available in the data feed.

Logical Data Model:

This section describes the logical design of the accessory processing system according to one embodiment. The section starts with a description of the implementation logical data model. Then it describes the outline of the software components used to maintain the data and consistency of the logical data model.

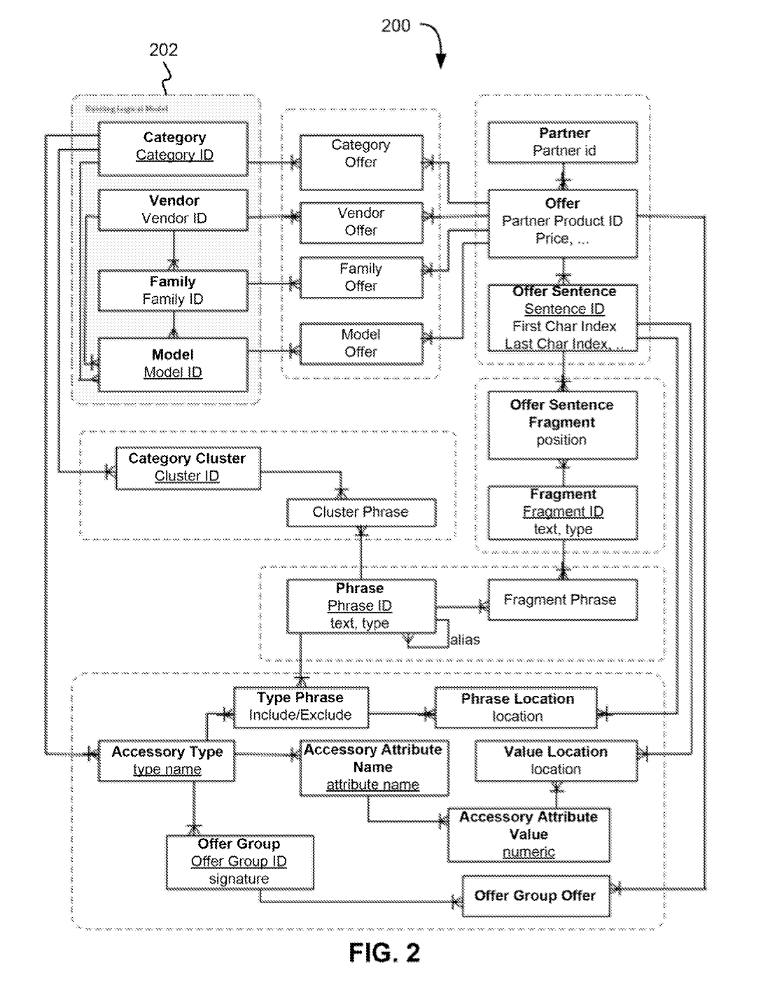

The Logical Data Structure (LDS) 200 shown in FIG. 2 describes the data and the relationship that may be maintained by the accessory processing implementation according to one embodiment. The logical data model is different from the conceptual model because the logical data model describes potential implementation designs. There are additional elements such as “clusters” that do not correspond to anything in the conceptual model. These additional elements may be employed in various implementations.

The logical data model may also be different from the physical data model because the logical data model may be programming language and storage independent. The physical implementation of the logical model, such as using a relational database or simple configuration files, is described below.

Referring to FIG. 2, the primary logical model 202 in one approach includes Category, Vendor, Family and Model components. Additional illustrative components are also shown, and described in more detail below. Alternative, fewer, and/or additional components may be used in other embodiments. The various components, once known, may be used to identify and/or classify the accessories, determine to which primary products the accessories belong, etc.

Category in one approach refers to the category of a primary product with which the accessory may be used. Category preferably does not refer to any accessory categories. About each Category, the system may determine and/or store one or more of the following:
Category ID, preferably no two categories have the same category ID
Category Name, etc.
Category Offers for accessories matching to this category
Models for this Category
Category Clusters which may represent a cluster of phrases from category offers belonging to this category
Accessory Types that may be associated with the offers belonging to this category

Vendor in one approach refers to the manufacturer of a primary product. Vendor preferably does not refer to any accessory manufacturer. About each Vendor, the system may determine and/or store one or more of the following:
Vendor ID, preferably no two vendors can have the same vendor id
Vendor Name, etc.
Product Families
Models
Model Offers for accessories matching to this vendor

Family in one approach refers to the family of a primary product. Family preferably does not refer to any accessory product family. About each Family, the system may determine and/or store one or more of the following:
Vendor and Family ID, preferably no two Families can have the same Vendor and Family ID
Models belonging to this family
Family Offers for accessories matching to this Family

Model in one approach refers to a primary product model. Model preferably does not refer to any accessory model. About each Model, the system may determine and/or store one or more of the following:
Vendor and Model ID, preferably no two Models can have the same Vendor and Model ID
Category this Model belongs to
Family this Model belongs to
Model Offers for accessories matching to this model

A Partner in one approach represents a seller, manufacturer, distributor, etc. About each Partner, the system may determine and/or store one or more of the following:
Partner ID, preferably no two Partners can have the same Partner ID
Partner Name, Address, and other seller information
Offers available from this partner

About each Offer, the system may determine and/or store one or more of the following:
Partner and Partner Product ID, preferably no two Offers can have the same Partner and Partner Product ID
Title
Description
Price
Offer Sentences that are parsed from the title and description
Category Offers for the primary product Categories this Offer is compatible with
Vendor Offers for the primary product Vendors this Offer is compatible with
Family Offers for the primary product Families this Offer is compatible with
Model Offers for the primary product Models this Offer is compatible with
Offer Group Offers this offer is a member of

A Category Offer is an offer associated with a particular category. About each Category Offer, the system may determine and/or store one or more of the following:
Category and Offer, preferably no two Category Offer can have the same Category and Offer
A Vendor Offer is an offer associated with a particular Vendor. About each Vendor Offer, the system may determine and/or store one or more of the following:
Vendor and Offer, preferably no two Vendor Offer can have the same Vendor and Offer

A Family Offer is an offer associated with a particular Family. About each Family Offer, the system may determine and/or store one or more of the following:
Family and Offer, preferably no two Family Offer can have the same Family and Offer

A Model Offer is an offer associated with a particular Model. About each Model Offer, the system may determine and/or store one or more of the following:
Model and Offer, preferably no two Model Offer can have the same Model and Offer

An Offer Sentence in one approach refers to a block of text in an Offer. The block of text may be found anywhere in the offer, and may include such things as a description of the primary product or accessory, name or model of the primary product or accessory, related products, vendor information, etc. About each Offer Sentence, the system may determine and/or store one or more of the following:
Offer and Sentence ID, preferably no two Offer Sentences can have the same Offer and Sentence ID
First, last character index
Title or description the sentence comes from
Parsed Offer Sentence Fragments
Value Locations for accessory attribute values extracted from this Offer Sentence
Phrase Locations for accessory type phrases for the identified types

A Fragment in one approach is a word or string of words in an Offer. It may represent a noun phrase in a sentence. About each Fragment, the system may determine and/or store one or more of the following:
Fragment ID, preferably no two fragments can have the same fragment ID
Text of the fragment
Type of the fragment such as title or description
Offer Sentence Fragments for sentences this Fragment appears in
Fragment Phrases for phrases from this fragment

An Offer Sentence Fragment in one approach is a word or string of words in an Offer Sentence. About each Offer Sentence Fragment, the system may determine and/or store one or more of the following:
Offer Sentence and Fragment, preferably no two Offer Sentence Fragments can be for the same Offer Sentence and Fragment
Position within the Offer Sentence the Fragment appears in

A Phrase in one approach refers to a set of contiguous words extracted from a fragment. A fragment comprising n words can be split into phrases by extracting all possible consecutive words of size 1 to n−1 from the fragment. About each Phrase, the system may determine and/or store one or more of the following:
Phrase ID, preferably no two Phrases can have the same Phrase ID
Text of the phrase
Type of the phrase such as singleton, bi-word, etc.
Cluster phrases for clusters this phrase is in
Phrases that this Phrase is a alias of
Another Phrase that is the alias of this Phrase
Fragment phrases for Fragments this phrase belong to
Type Phrases for Types this phrase is configured in

A Fragment Phrase in one instance is an object representing a phrase and the fragment it occurs in. About each Fragment Phrase, the system may determine and/or store one or more of the following:
Phrase and the Fragment it was extracted from, preferably no two Fragment Phrases can have the same Phrase and Fragment

The set of phrases extracted from all offers belonging to a category can, in one approach, be clustered to yield similar phrases. Each cluster may be represented in terms of a Category Cluster. About each Category Cluster, the system may determine and/or store one or more of the following:
Category and Cluster ID, preferably no two clusters can have the same category and cluster ID
Cluster Phrases in this Category Cluster

A Cluster Phrase in one approach may represent a phrase in a cluster. About each Cluster Phrase, the system may determine and/or store one or more of the following:
Category Cluster and Phrase, no two Cluster Phrase can be for the same Category Cluster and Phrase

About each Accessory Type, the system may determine and/or store one or more of the following:
Category and type name, preferably no two Accessory Types can have the same Category and Type Name.
Type Phrases belonging to this Accessory Type
Offer Groups for this Accessory Type
Accessory Attribute Names for this Accessory Type

A Type Phrase in one approach refers to a phrase that can be used to classify an offer into an accessory type. It may contain information on whether the phrase has a positive (inclusion) or a negative (exclusion) effect for a given Accessory Type. About each Type Phrase, the system may determine and/or store one or more of the following:
Accessory Type and Phrase, preferably no two Type Phrase can have the same Accessory Type and Phrase
Inclusion/exclusion characteristic.
Phrase Locations for where in the offer this Type Phrase appears

A Phrase Location in one approach may represent where a Type Phrase occurs in an Offer Sentence. If a Type Phrase occurs in more than one location in an Offer Sentence, the multiple Phrase Location objects may be required to store the locations, one for each occurrence. About each Phrase Location, the system may determine and/or store one or more of the following:
Type Phrase and Offer Sentence, preferably no two Phrase Location can be for the same Type Phrase and Offer Sentence.
The location within the Offer Sentence where the phrase occurs

An Accessory Type in one approach may include a number of Attributes. Each Attribute may be represented by a name and a set of values. About each Accessory Attribute Name, the system may determine and/or store one or more of the following:
Accessory Type and Attribute Name, preferably no two Accessory Attribute Names have the same Accessory Type and Attribute Name.

An Accessory Attribute in one approach may be represented by an Accessory Attribute Name and a set of Accessory Attribute Values. About each Accessory Attribute Value, the system may determine and/or store one or more of the following:
Accessory Attribute Name and numeric value, preferably no two Accessory Attribute Values can have the same Accessory Attribute Name and numeric value

A Value Location in one approach represents the location of the Attribute Value in an Offer Sentence. Multiple Value Location objects may be needed to represent the multiple occurrences of an Attribute Value in n Offer Sentence. About each Value Location, the system may determine and/or store one or more of the following:
Accessory Attribute Value and Offer Sentence, preferably no two Value Locations can be for the same Accessory Attribute Value and Offer Sentence.
Location within the Offer Sentence that this attribute value is located

A set of Offers in one approach may be grouped into clusters of similar Offers based on one or more of the Models or Families or Vendors or Categories or Accessory Types or Accessory Attribute Names or Accessory Attribute Types associated with the Offers. About each Offer Group, the system may determine and/or store one or more of the following:
Offer Group ID, preferably no two Offer Groups can have the same Offer Group IDs
Accessory Type for which this Offer Group belongs to
Signature that contains information such as attribute value vector, model vector, etc. As an example, the Attribute Value Vector may represent the set of Attribute Values associated with the group of Offers associated with the Offer Group.

An Offer Group Offer object in one approach may represent how an Offer is related to an Offer Group. About each Offer Group Offer, the system may determine and/or store one or more of the following:
Offer Group Offer and Offer, preferably no two Group Offers can share the same Offer Group and Offer

Functional Components:

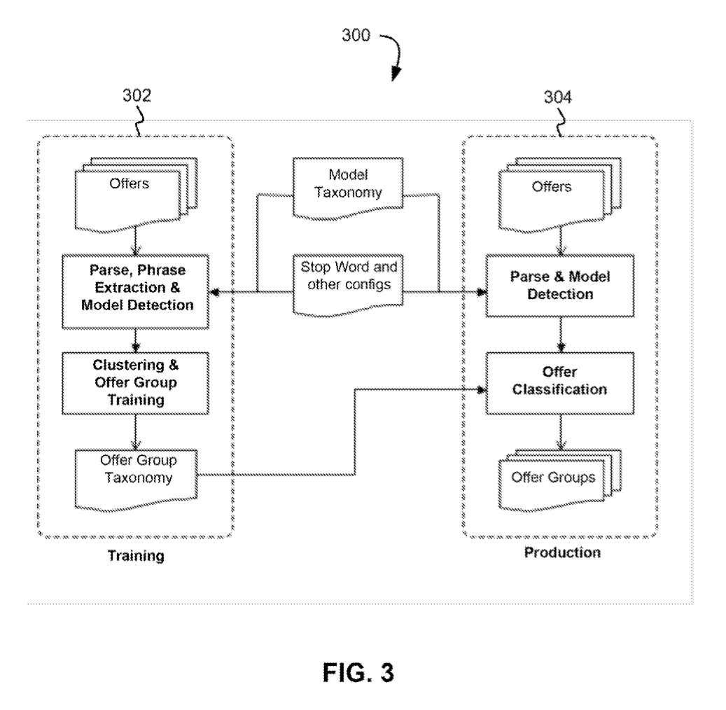

In some embodiments, several functional components work independently to populate and maintain the data in the logical data model. The components may be linked together via input data and output data in a process. The overall process, an embodiment 300 of which is shown in FIG. 3, breaks down into two main areas: accessory training 302 and production classification 304. Accessory Training is used to discover accessory types, accessory attribute names, and offer groups. The result of training is a taxonomy that contains type, subtype, offer group relationship as well as a unique signature for each offer group. Training may happen periodically such as once a week using the real offers in the system, daily; upon occurrence of an event, such as upon receiving a feed, upon receiving a request to train or retrain, etc. The steps used in accessory training are described below.

Production classification in one embodiment takes new offers, parses and detects the model, and then classifies them into one or more of the offer groups that are defined from the training stage. Production classification may occur in real time as soon as the offers are uploaded into the system, or later. The process of production classification is described below.

Training Process:

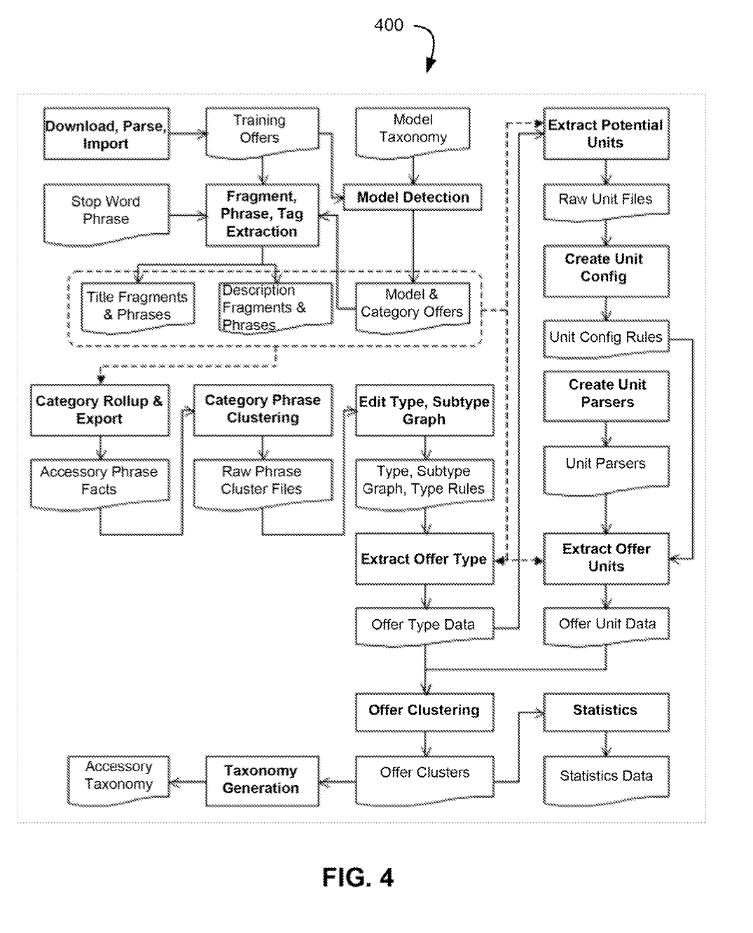

FIG. 4 depicts a process 400 for accessory training, according to one embodiment.

The various components shown may include operations, inputs, outputs, and/or data. Moreover, various embodiments of the present invention may include more, less or alternate components than those shown. Illustrative components include:
Accessory Data Download—This component downloads partner data feeds and deposits them into local data store (db or file system).
   Input: Download feeds file (from partners)
   Output: Generate file per high-level feed file
Parse—creates individual accessory offers from downloaded data feed. It may also normalize and convert each downloaded feed into a common format and/or parse out individual offer data.
   Parse offer title
   Offer description
   Offer Manufacturer
   Offer Images
   Offer Prices
   Offer Merchants
Import—imports the parsed offers into the local data store
Offer Processing
   Identify compatible models, vendors, and categories for accessory offers. Also associates a confidence score to each model, vendor, or category
   Fragment Extractor—extracts sentence fragments from offers. Sentence fragments are defined as contiguous words that are separated by stopwords, sentence phrase separator punctuation marks, or compatible vendor, family, model, category keywords.
   Phrase Extractor—extracts a set of bi-words (or n-words) from within fragments contained offer title and description. It may also extract single word fragments.
   Tag Extractor—extracts pre-defined phrases from title and description phrases. Also extracts all other singleton words not present in the manually defined phrases from bi-word phrases.
Category Phrase Cluster
   Count phrase occurrence in title or description of offers belonging to a particular category
   Cluster phrases based on subsumption (n % of offers in subsumed cluster are in the parent cluster)
Type Graph Generator
   Generate a raw graph representing parent child relationship based on Category Phrase Cluster data—a node is a child node to a parent node if the offers associated with its phrase are subsumed by the offers associated with the phrase of the parent node.
   Create subset of the raw graph including top level nodes (that have no parents) with at least n-offers and m-children and children which have n′-offers or m′-children. Create a single type graph with all the nodes defined above.
Sub-type Graph Generator
   Generate sub-type graphs for each type graph, where a sub-type graph represents the entire graph centered at the parent node that represents a type. These graphs are further manually edited to better define relationships between phrases and the accessory type.
Type Rule Generation/Update
   Manually modify the graph to include, remove, or modify nodes and edges. The nodes and edges have styles and colors associated with them and define which nodes (phrases) in the type graph are to be used as an inclusion, exclusion, or ignore set for classifying offers.
   Run through the type rule generation that reads the previous type graph, current raw graph and generates the category type rules
Training Set Classifier and Potential Units Extractor
   Read in all category type rules
   Get all offers associated with a category (either via category or modelID's category)
   Find all category type rules that apply to the offer
   Associate offer with a category type only if one category type rule applies for that offer for that category
   Extract all potential units from offer that is associated with a particular category type rule
      Potential units extracted from all title and description fragments
      Split fragment by numbers and use single word and multi-word phrases before and after the number as potential unit
      Read pre-defined units from config files
      Maintain unit occurrence counts over all offers associated with the accessory type
Category Type Unit Config Generation
   Use output from potential units files and identify real units
   Define the config files describing the key units
Category Type Unit Parser Generation
   Manually create the parsers for various units—this may involve use of regular expressions and/or string processing
   Create generic parsers as base classes
   Associate each unit with a parser (generic or specialized) in the units config file
Offer Classification into Category Type and Unit (and other Feature) Extraction
   For each category, get all offers and classify each offer into accessory types
   Extract units (and other features) and store data (lists of units and offer title) from each offer based on the unit/feature config files and the parsers defined above.
Offer Clustering based on Category Type Unit Classification
   Cluster offers based on category/vendor/model match, title match, and units match. A cluster represents an offer group.
   Each offer group is assigned a signature/set of signatures based on the categories, models, vendors, accessory type, units, etc.)
   An offer can belong to more than one offer group
Export to Production
   Export offer group data to production. The exported data include offer group to categories/vendors/models mapping, offer group to accessory types mapping, offer group to accessory units mapping, and offer group to individual offers mapping for all the offer groups.

In one illustrative process, a computer-implemented training process includes operations corresponding generally to similarly-named components of FIG. 4. The illustrative training process includes obtaining accessory offers; parsing the offers to extract information such as title/description/images/prices, etc., about the accessories described in the offers; determining compatibility information from the extracted information about the accessories; extracting phrases from the extracted information about the accessories; clustering the extracted phrases; generating type graphs, receiving user input for manually editing the type graphs; generating type rules; classifying the offers into particular accessory types based on the type rules; identifying features for the accessory types; generating parsers for feature extraction; extracting features (e.g., units) from offers classified into the particular accessory types; and clustering the offers into offer groups based on compatibility, corresponding accessory types in which the offers are classified, and the features extracted from the offers. Optionally, the offer groups may be stored and/or exported to a production system.

Production Process:

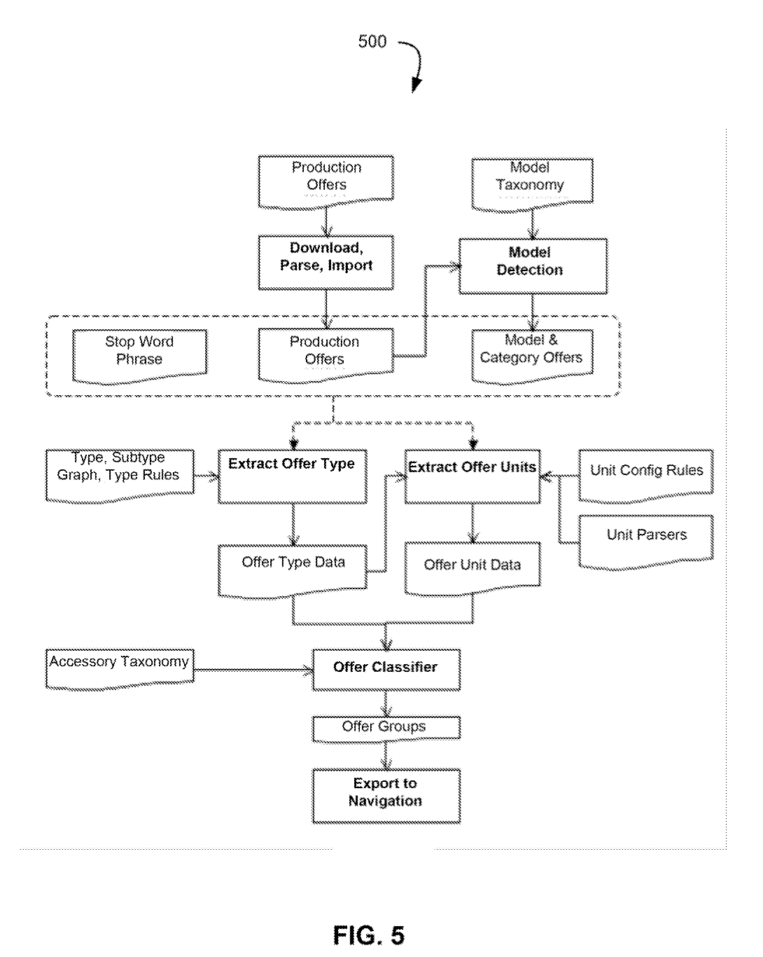

FIG. 5 depicts a process 500 for accessory production according to one embodiment.

The various components shown may include operations, inputs, outputs, and/or data. Moreover, various embodiments of the present invention may include more, less or alternate components than those shown.

The production process in one embodiment shares many of the same components/functions as the training process. One difference may be that the production process is completely automated and there are no manual (human-input) steps. One embodiment applies all the rules and classifiers defined in the training step on new, real-time partner data feeds. The goal in one approach is to take each new offer and classify it into one or more pre-existing offer groups. If a new offer cannot be associated with an existing offer group then a new offer group is created and the offer is inserted into the new offer group. Subsequent new offers may get associated with this newly created offer group. Illustrative components include:
Accessory Training data for import classification purposes
   Creates a map of offer groups accessed by offer group signature
   Create a fixed navigation hierarchy from larger more general offer groups to smaller more specific offer groups
Periodically download accessory production offer data from partner(s)
Perform the following steps within an hour after receiving the data
   Create a list of offers that have been added, changed or removed
   Classify offer data into N offer groups using offer signature to offer group signature similarity
   Insert the offer data into the matching offer groups and hence into the fixed navigation hierarchy
   Remove existing offer data that is not present in the current partner download
   Update offer inventory to reflect current inventory level of each offer

In one illustrative process, a computer-implemented production process includes operations corresponding generally to similarly-named components of FIG. 5. The illustrative production process includes obtaining one or more accessory offers; parsing the one or more accessory offers to extract information, e.g., title/description, etc. about the accessories; determining compatibility information from the extracted information; extracting phrases from the information about the accessories; using the extracted phrases to classify the offers based on type rule definitions; extracting features (e.g., units) from the offers classified into accessory types; generating an offer signature based on one or more of compatibility, accessory types, and accessory features associated with the input accessory offer.

As an option, at least some of the offers may be classified into a pre-existing set of offer groups based on the signature of each of the at least some of the offers. As another option, at least one of the offers may be classified into a new offer group if it cannot be classified into a set of pre-existing offer groups based on the signature of the at least one offer.

Accessory Type Classification:

This section describes an illustrative process for classifying accessory offers to accessory types. While this section only shows the “type classification” stage of the process, similar methodology may be used to determine accessory compatibility and/or accessory features in some embodiments.

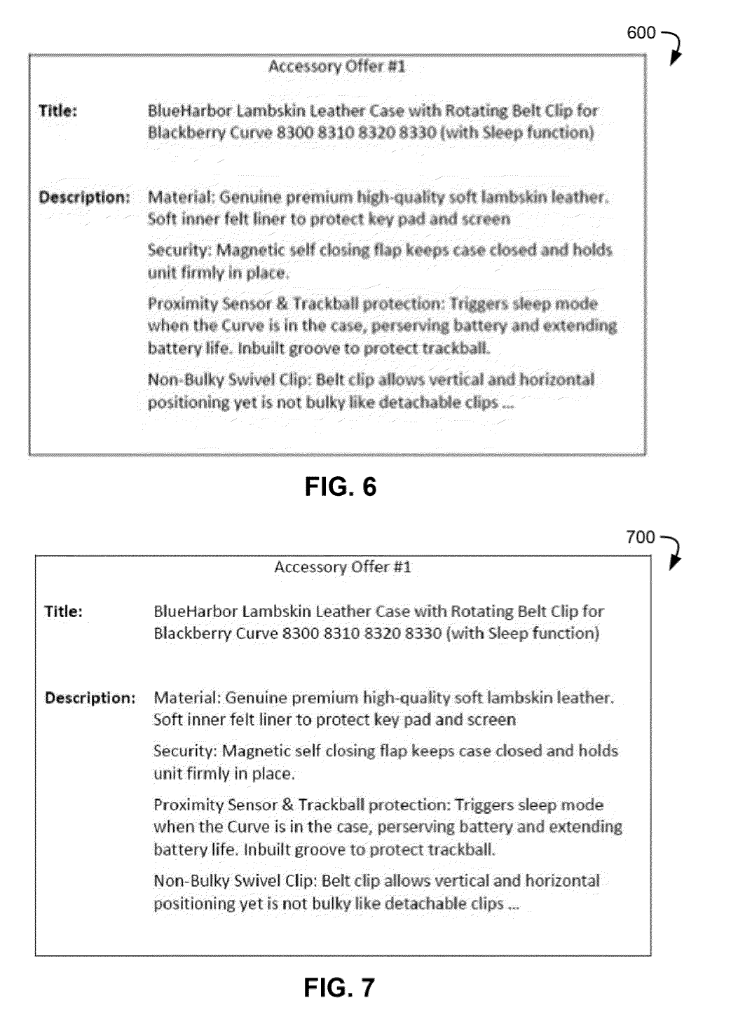

Referring to FIG. 6, there is shown an illustrative accessory offer 600. As shown, the offer includes a title and description text. High frequency words and phrases (e.g., bi-words, strings of words, etc.) are identified and extracted from the title and description. See FIG. 7, which includes a representation 700 of some of the words and bi-words that may be extracted from the offer of FIG. 6. This extraction is performed for all accessory offers from a category.

The words and phrases are grouped and/or categorized based on one or more statistics such as their frequency of appearance in the offers, how many offers have the word or phrase, position on the page, etc. This allows creation of relationships between the words and phrases, which can conceptually be thought of as a tree or chart of relationships. At the top most level, there may be various words and phrases, preferably high frequency words and phrases such as battery, adapter, charger, etc. Other words and phrases may be deemed children of higher-level words or phrases. For example, assume words and phrases are extracted from offers in a category such as accessories for cell phones. Next, assume phrase A is found in twenty offers, and phrase B is found in forty offers, the twenty offers with phrase A are found in the forty offers with phrase B. It is deduced that phrase A is a child of phrase B, and so on. Thus, assuming phrase B is “charger” and phrase A is “travel charger,” then travel charger is determined to be a child phrase of charger, and a travel charger can be associated with the accessory type “charger” as a charger and/or as a sub-type of a charger.

One embodiment implements a rule set that indicates that particular words and phrases are associated with a particular accessory type. In one approach, the rule set may include an inclusion set. Moreover, the rule set may include both an inclusion set and an exclusion set such that if a phrase in the inclusion set appears in the offer and the phrase is not in the exclusion set, the accessory type associated with the inclusion set is selected for that offer. The rule set can be manually defined, generated using classification techniques, etc.

Some approaches implement a “fuzzy logic” approach where multiple words and phrases may be placed into multiple groups. Assume, for example, that an offer is for a bundle that includes a charger, a battery and a memory card for a mobile phone. The bundle may be associated with three different types of categories, one for each of the components.

In one approach, a user may manually create, verify, and/or alter the groupings. For example, the system may receive user input indicating that “charger” is an accessory type, and that “travel charger” is a sub-type of charger. In another approach, classification is used to create the groupings of phrases and words. Any classification technique known in the art may be used, such as transduction, MED, support vector machine (SVM), etc. classification. In general, training examples are provided to create a classifier. For example, “travel charger” can be listed as a sample of what should go under the charger “category.” Once the training examples are defined and the classifier is properly trained, then going forward, portable chargers or car chargers should always be grouped under charger.

The particular process used may be iterative, where the first level processing organizes the words and phrases based on frequencies, position in the text, etc. The way the data is structured may include false positives, e.g., a battery charger may be organized as a type of battery. Thus, further refinement of the organizations can be performed, additional rules implemented, rules changed, etc. Such further refinement may be automated, performed manually, etc. Once the refinement is performed, the system has knowledge that may be used to process new accessory offers with little or no further training.

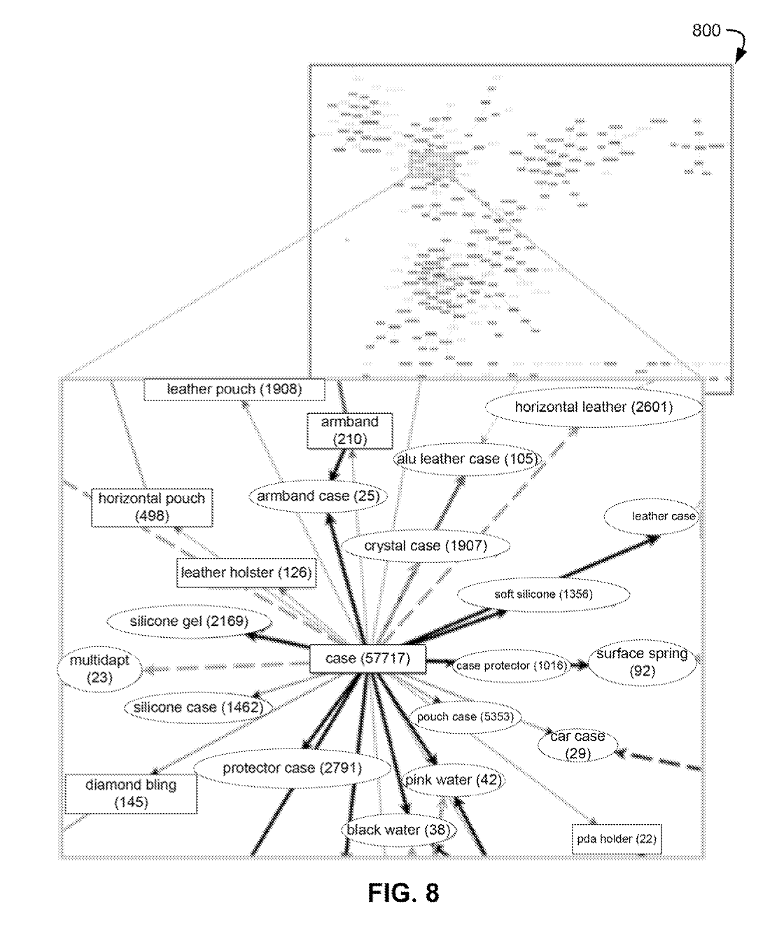

In one approach, word and phrase clustering across all accessory offers inside an accessory category is performed. FIG. 8 depicts an illustrative clustering graph 800 that can be generated according to one embodiment. Links in the clustering graph depict word and bi-word relationship. As shown in FIG. 8, the term “case” was found 57717 times and so is deemed a primary type. Other terms and phrases having fewer occurrences are associated with “case.” A user may manually edit this graph to remove false positive relationships and/or add missing relationships. For example, assume “battery charger” has 5000 hits and is shown on a chart as being associated with “battery,” which has 10000 hits. The user may sever the link between battery charger and battery, thereby creating an exclusion. The user may also remove terms that are irrelevant. Once the relationships are deemed proper, the system may then use the word and phrase relationships to classify each accessory offer to one or more accessory types.

Note that if the compatibility determination has already been made, the various offers for accessories can be sorted out by primary product. The clustering process tends to be more accurate when performed on offers only having a particular compatibility.

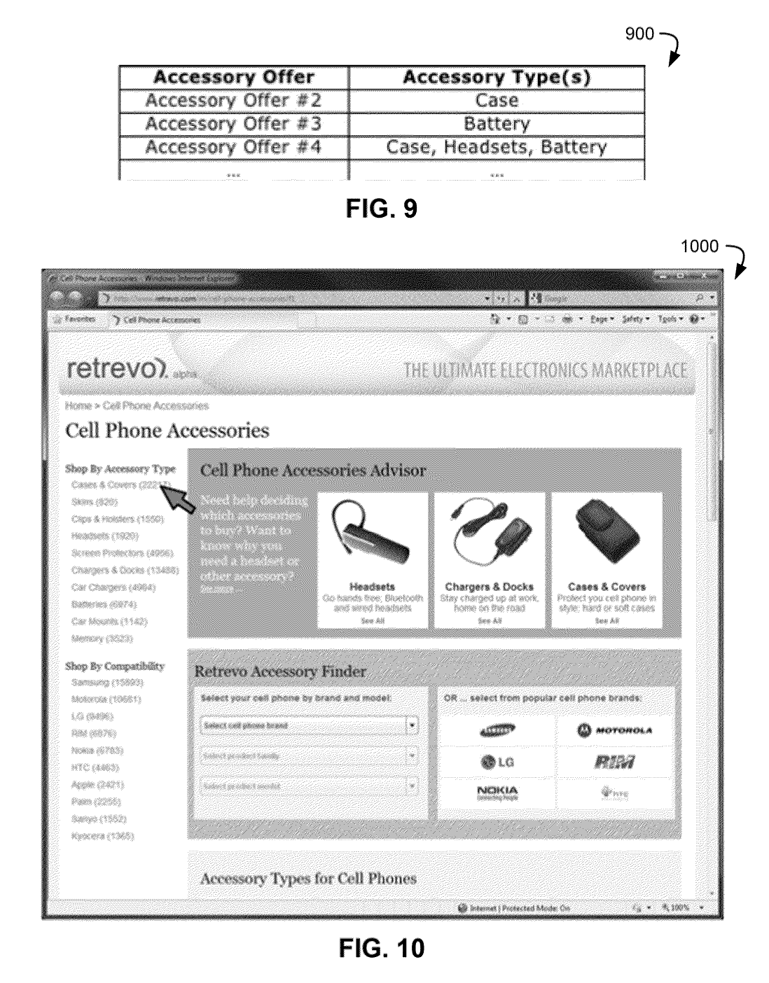

FIG. 9 illustrates a table 900 storing the association of accessory offers with one or more accessory types.

In one illustrative approach, the raw data is processed so that a huge amount of description is condensed down into a smaller set of key words and phrases. The key words and phrases are organized in a logical manner, and then an operator gives meaning to higher level words and phrases. Thus, the system is trained, for example, to know that “flash” has a meaning when used in an offer with the term “memory”, “memory” has a meaning, “compact flash” has a meaning. Thus, the system may be trained by looking at a few tens or hundreds of offers rather than two million offers, giving key words and phrases meaning, and using the now-trained system to classify all desired offers.

Once the system is trained, the previously-processed accessory offers may be reprocessed and classified into the proper groups. Additional offers may also be processed.

In some approaches, a further clustering may be used to further define the accessory type and/or determine accessory features. For example, by analyzing offers for batteries, the same technique can be used to generate clusters based on frequency of recurrences of certain words, such as volts, amps, pack (e.g., two pack or five pack), etc. The recurrences appear as patterns, particularly where they are numbers associated with them. Based on this, certain words and phrases can be marked as important, and used to determine accessory type, and/or accessory features. Moreover, terms such as volts can be defined as a feature and any number adjacent thereto in the offer can be extracted as a value of that feature.

Illustrative User Interface:

FIGS. 10-18 depict illustrative user interfaces in which the grouped accessory information may be output and optionally navigated. Note that these screenshots are presented by way of example only, and various implementations may include more, fewer, and/or alternative groupings, lists, categories, etc. than those shown.

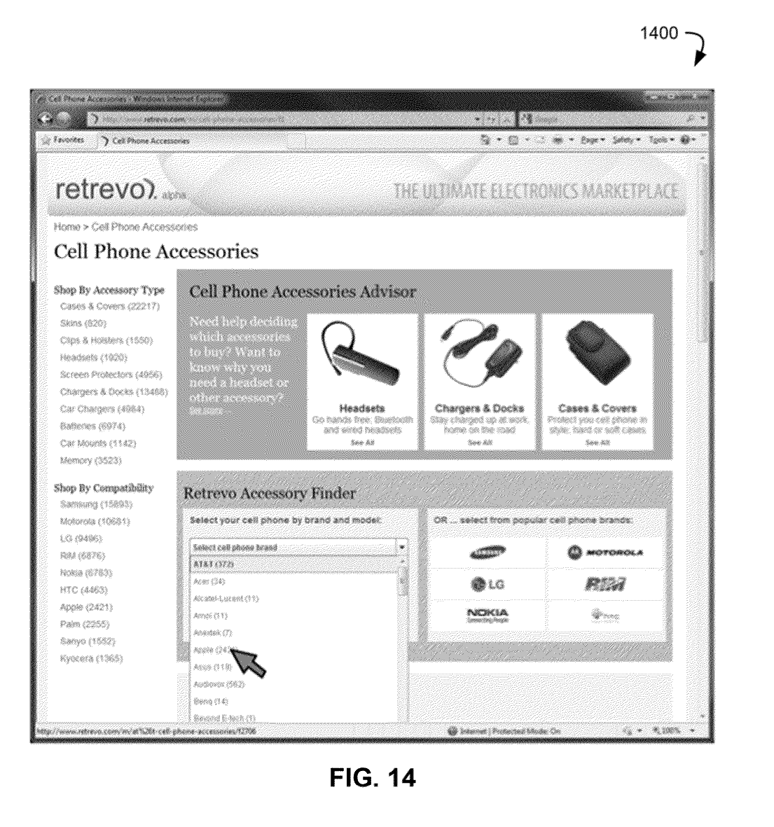

In the examples shown, FIGS. 10-13 illustrate one potential sequence of navigation: “top”->“select accessory type”->“select accessory feature”->“select a offer group”. FIGS. 14-18 illustrate a second potential sequence of navigation: “top”->“select compatibility brand”->“select accessory type”->“select accessory feature”->“select a offer group”.

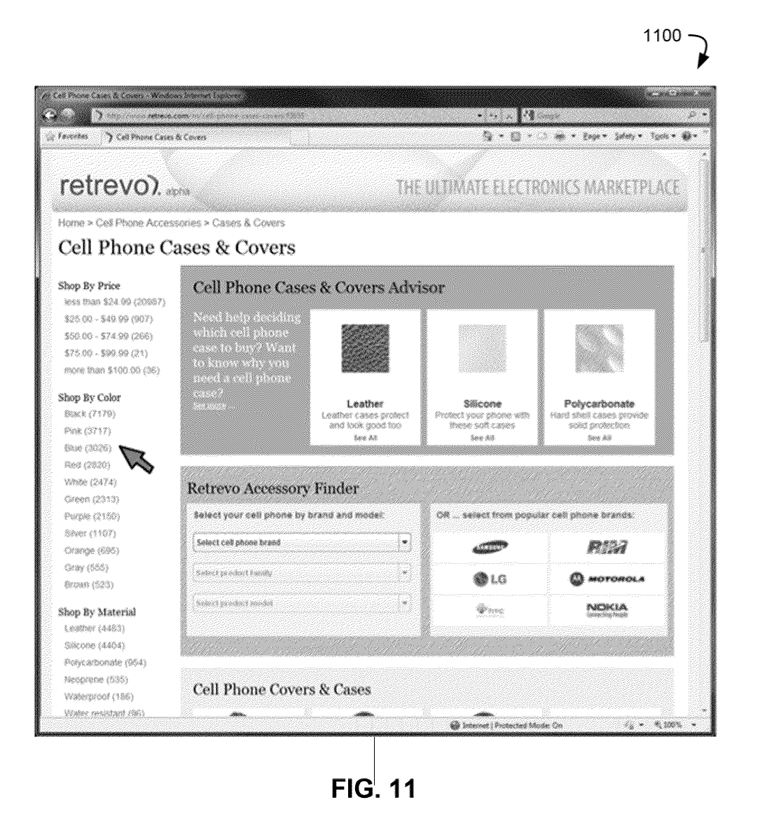

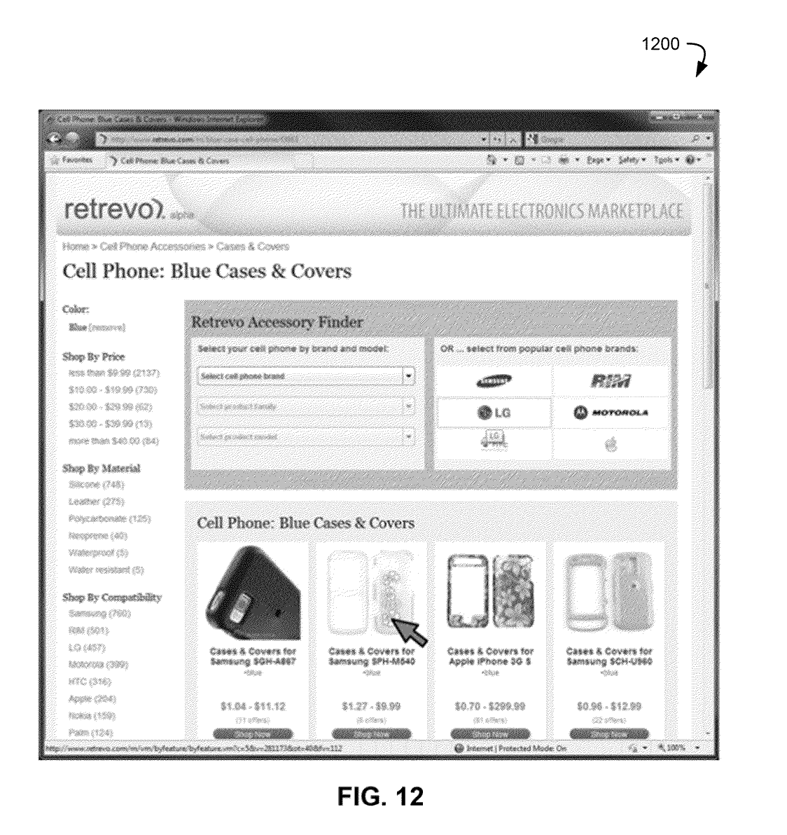

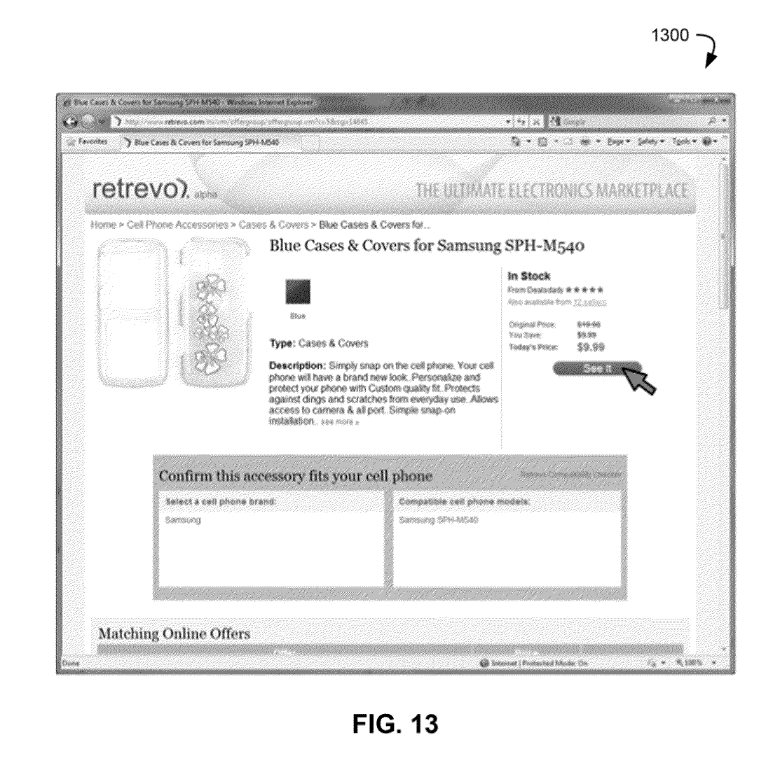

Referring to FIG. 10, a main accessories page 1000 for cell phone accessories may be output. Note that links to groups of accessories are provided by accessory type and compatibility. The accessory finder tool allows for focused searching. Searching by primary product brand is also provided. Assume that “Cases & Covers” is selected from the list of accessory types. The system then outputs a cases and covers page 1100, as shown in FIG. 11. Lists of product features are presented. Assume the link “Blue” is selected from the list of color features. The system outputs the blue cases and covers page 1200 shown in FIG. 12. Features are again listed, as is compatibility. Assume the link “Cases & Covers for Samsung SPH-M540” is selected. The system outputs the screen 1300 shown in FIG. 13. This screen includes a picture of the accessory, a description of the accessory, the compatibility, a price for the accessory, and a link to a vendor. Note that multiple prices may be shown, as well as multiple links to vendors may be provided. Moreover, a button to add the accessory to a shopping cart may be provided.

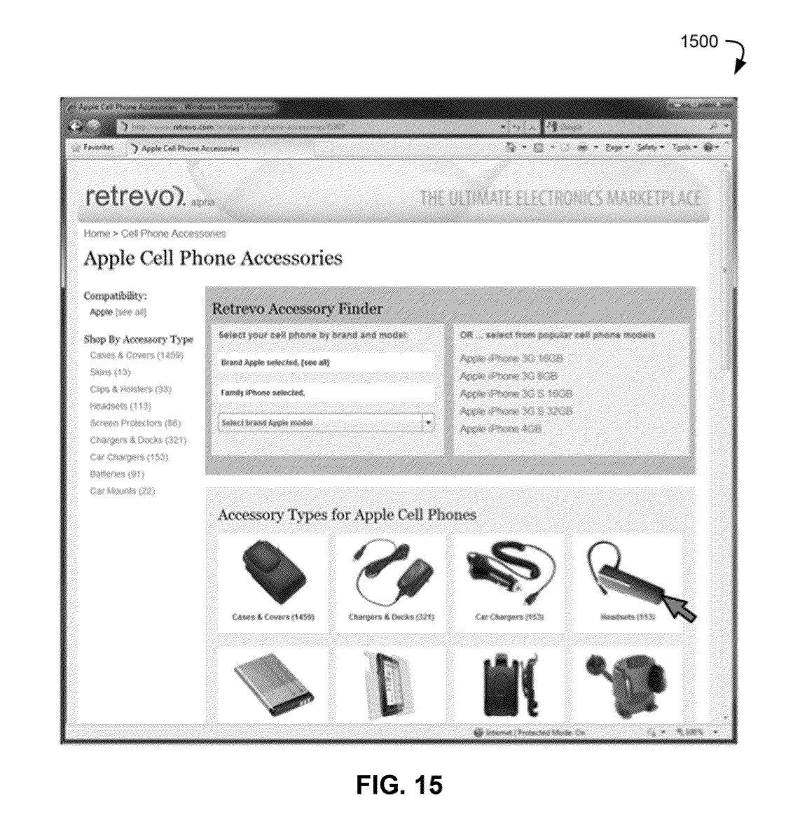

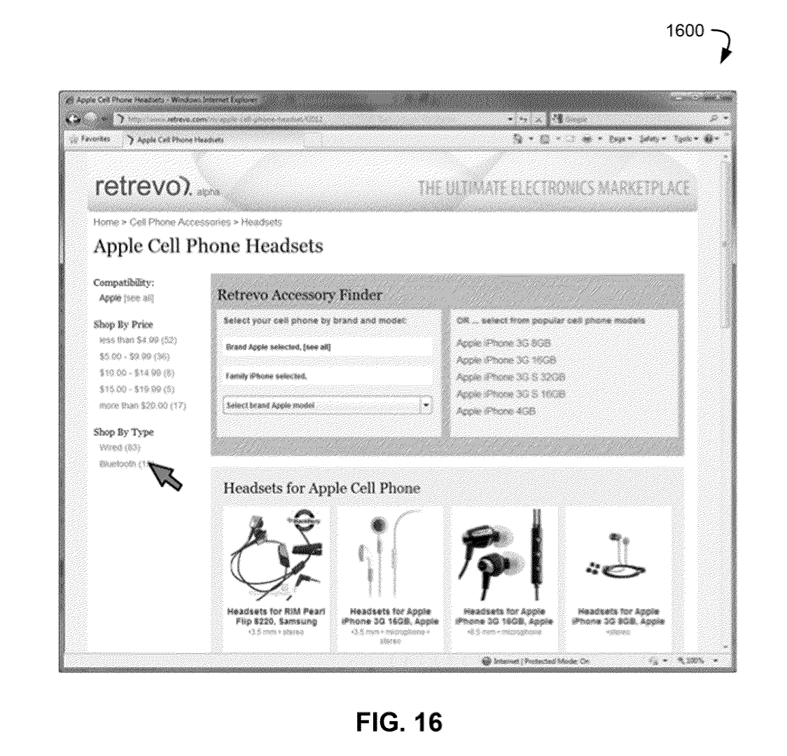

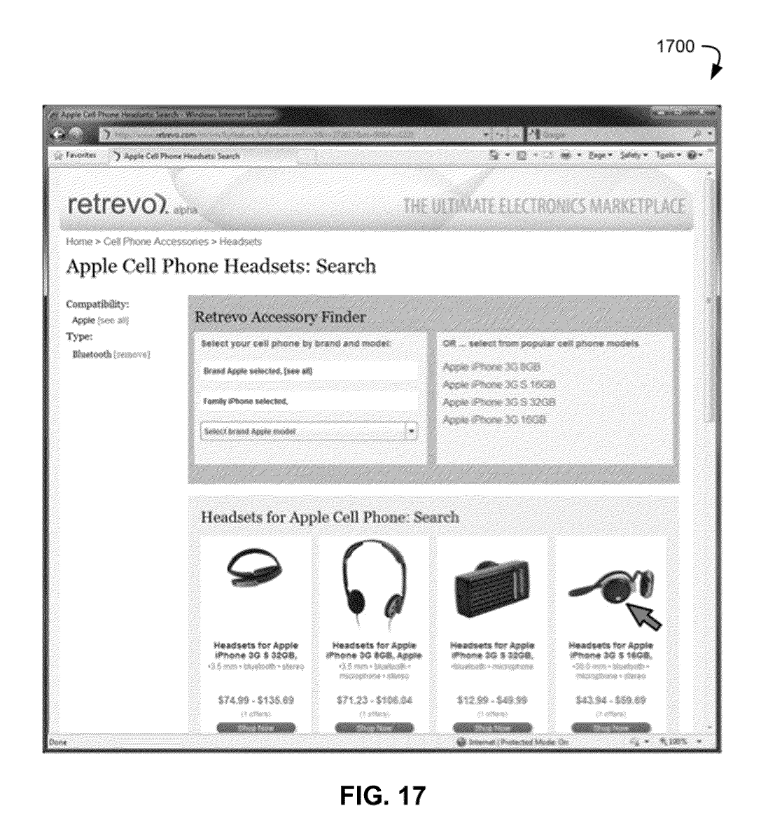

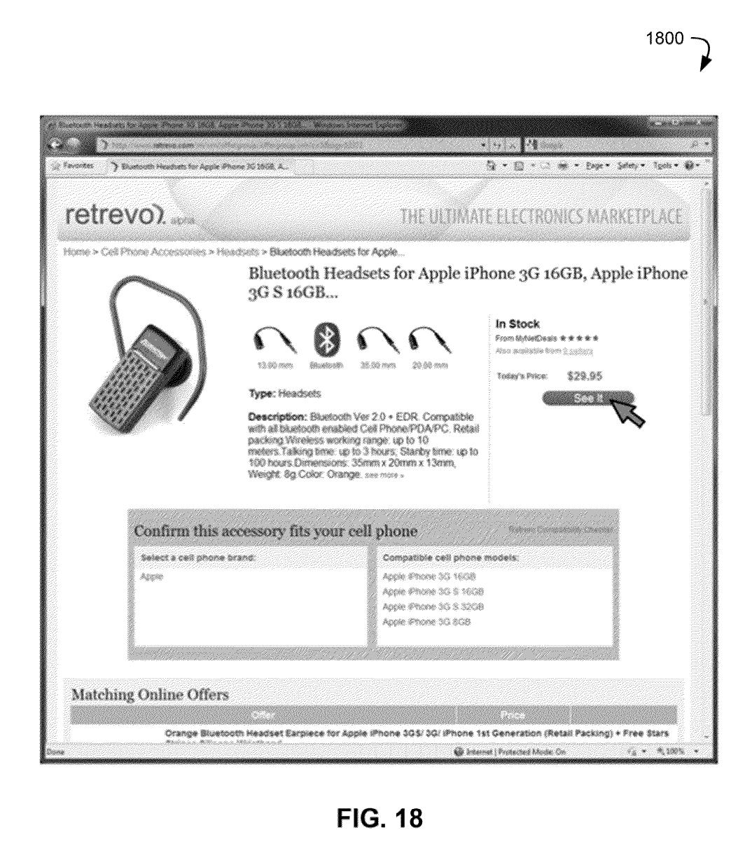

Referring to FIG. 14, the main accessories page 1400 for cell phone accessories is shown again, this time with a “Select cell phone brand” drop down menu open. Assume “Apple” is selected from the menu. The system outputs the screen 1500 shown in FIG. 15, which shows accessories for Apple brand phones. As shown, the accessory types are listed, as are various models of Apple brand phones. Drop down menus are also presented. Assume the link “Headsets” is selected. The system outputs the screen 1600 shown in FIG. 16, which lists types of headsets, features, and compatible primary products, among other things. Assume the link “Bluetooth” is selected. The system outputs the screen 1700 shown in FIG. 17, which again includes drop down menus, compatible primary products, and various accessories. Assume the link “Headsets for Apple iPhone 3G S 16GB” is selected. The system outputs the screen 1800 shown in FIG. 18, which is the offer group page for the headsets for the Apple iPhone 3G S 16 GB.

System/Method Environment

The present description is presented to enable any person skilled in the art to make and use the invention and is provided in the context of particular applications of the invention and their requirements. Various modifications to the disclosed embodiments will be readily apparent to those skilled in the art and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

In particular, various embodiments discussed herein are implemented using the Internet as a means of communicating among a plurality of computer systems. One skilled in the art will recognize that the present invention is not limited to the use of the Internet as a communication medium and that alternative methods of the invention may accommodate the use of a private intranet, a LAN, a WAN, a PSTN or other means of communication. In addition, various combinations of wired, wireless (e.g., radio frequency) and optical communication links may be utilized.

The program environment in which a present embodiment of the invention may be executed illustratively incorporates one or more general-purpose computers or special-purpose devices such facsimile machines and hand-held computers. Details of such devices (e.g., processor, memory, data storage, input and output devices) are well known and are omitted for the sake of clarity.

It should also be understood that the techniques presented herein might be implemented in logic using a variety of technologies. For example, the methods described herein may be implemented in software running on a computer system, and/or implemented in hardware utilizing, for example, one or more microprocessors or other specially designed application specific integrated circuits, programmable logic devices, or various combinations thereof; and combinations of hardware and software. In one approach, methods described herein may be implemented by executing a series of computer executable instructions residing on a storage medium such as a carrier wave, disk drive, or computer readable medium. In addition, although specific embodiments of the invention may employ object-oriented software programming concepts, the invention is not so limited and is easily adapted to employ other forms of directing the operation of a computer.

Various embodiments can also be provided in the form of a computer program product comprising a nontransitory computer readable medium having computer code thereon. A computer readable medium can include any medium capable of storing computer code thereon for use by a computer, including optical media such as read only and writeable CD and DVD, magnetic memory, semiconductor memory (e.g., FLASH memory and other portable memory cards, etc.), etc. Further, such software can be downloadable or otherwise transferable from one computing device to another via network, wireless link, nonvolatile memory device, etc.

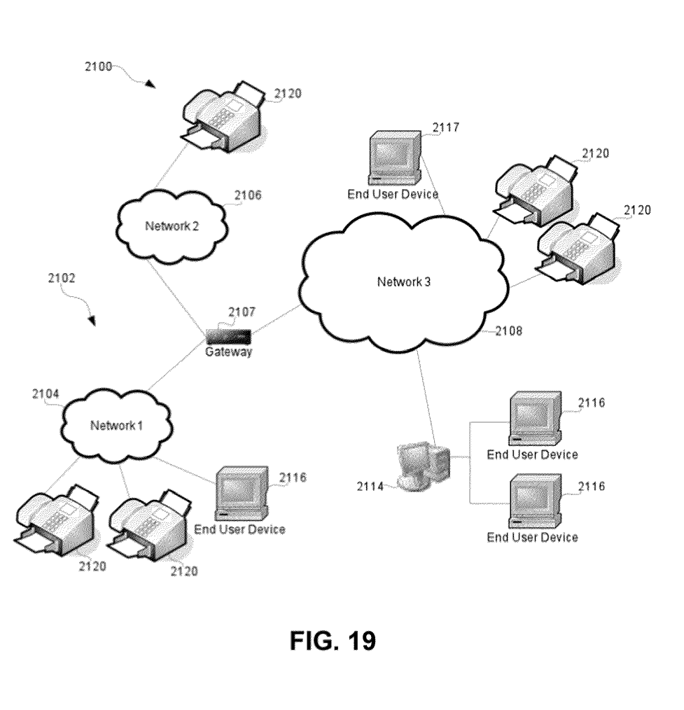

FIG. 19 illustrates a network architecture 2100, in accordance with one embodiment. As shown, a plurality of remote networks 2102 are provided including a first remote network 2104 and a second remote network 2106. A gateway 2107 may be coupled between the remote networks 2102 and a proximate network 2108. In the context of the present network architecture 2100, the networks 2104, 2106 may each take any form including, but not limited to a LAN, a WAN such as the Internet, PSTN, internal telephone network, etc.

In use, the gateway 2107 serves as an entrance point from the remote networks 2102 to the proximate network 2108. As such, the gateway 2107 may function as a router, which is capable of directing a given packet of data that arrives at the gateway 2107, and a switch, which furnishes the actual path in and out of the gateway 2107 for a given packet.

Further included is at least one data server 2114 coupled to the proximate network 708, and which is accessible from the remote networks 2102 via the gateway 2107. It should be noted that the data server(s) 2114 may include any type of computing device/groupware. Coupled to each data server 2114 is a plurality of user devices 2116. Such user devices 2116 may include a desktop computer, lap-top computer, hand-held computer, printer or any other type of logic. It should be noted that a user device 2117 may also be directly coupled to any of the networks, in one embodiment.

A peripheral device 2120 or series of peripheral devices 2120 such as printers, network storage, etc. may be coupled to one or more of the networks 2104, 2106, 2108. It should be noted that databases and/or additional components may be utilized with, or integrated into, any type of network element coupled to the networks 2104, 2106, 2108. In the context of the present description, a network element may refer to any component of a network. Moreover, the user device may be a computer, handheld device, portable device, telephone, etc.

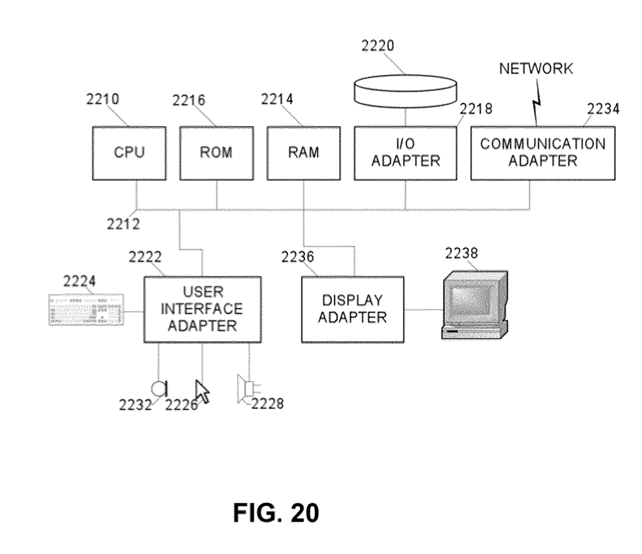

FIG. 20 shows a representative hardware environment associated with a user device 2116 of FIG. 19, in accordance with one embodiment. Such FIG. illustrates a typical hardware configuration of a workstation having a central processing unit 2210, such as a microprocessor, and a number of other units interconnected via a system bus 2212.

The workstation shown in FIG. 20 includes a Random Access Memory (RAM) 2214, Read Only Memory (ROM) 2216, an I/O adapter 2218 for connecting peripheral devices such as disk storage units 2220 to the bus 2212, a user interface adapter 2222 for connecting a keyboard 2224, a mouse 2226, a speaker 2228, a microphone 2232, and/or other user interface devices such as a touch screen and a digital camera (not shown) to the bus 2212, communication adapter 2234 for connecting the workstation to a communication network 2235 (e.g., a data processing network) and a display adapter 2236 for connecting the bus 2212 to a display device 2238.

The workstation may have resident thereon an operating system such as the Microsoft Windows® Operating System (OS), a MAC OS, or UNIX operating system. It will be appreciated that a preferred embodiment may also be implemented on platforms and operating systems other than those mentioned. A preferred embodiment may be written using JAVA, XML, C, and/or C++ language, or other programming languages, along with an object oriented programming methodology. Object oriented programming (OOP), which has become increasingly used to develop complex applications, may be used.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

1. A computer-implemented method, comprising:
for each of a plurality of accessories:
determining a compatibility of an accessory;
determining a type of the accessory;
determining features of the accessory; and
associating the accessories into logical groups based on the compatibility, type and features thereof.

2. The method of claim 1, further comprising generating user interface navigation data for the logical groups of accessories based on values associated with one or more of the compatibility of accessories in logical groups, the type of accessories in logical groups, and the features of accessories in the logical groups.

3. The method of claim 1, further comprising generating a signature for each of the accessories based on one or more of the compatibility of the accessory, the type of the accessory, the features of the accessory, a title of the accessory, and a description of the accessory.

4. The method of claim 3, further comprising classifying the accessories into logical groups based on the signatures associated therewith.

5. A computer program product embodied on a nontransitory computer readable medium, comprising:
computer code for determining a compatibility of an accessory;
computer code for determining a type of the accessory;
computer code for determining features of the accessory; and
computer code for associating the accessories into logical groups based on the compatibility, type and features thereof.

6. The computer program product of claim 5, further comprising computer code for generating a user interface navigation for the logical groups of accessories based on values associated with one or more of the compatibility of accessories in logical groups, the type of accessories in logical groups, and the features of accessories in the logical groups.

7. The computer program product of claim 5, further comprising computer code for generating a signature for each of the accessories based on one or more of the compatibility of the accessory, the type of the accessory, the features of the accessory, a title of the accessory, and a description of the accessory.

8. The computer program product of claim 7, further comprising computer code for classifying the accessories into logical groups based on the signatures associated therewith.

9. A system, comprising:
logic for determining a compatibility of an accessory;
logic for determining a type of the accessory;
logic for determining features of the accessory; and
logic for associating the accessories into logical groups based on the compatibility, type and features thereof.

10. The system of claim 9, further comprising logic for generating a user interface navigation for the logical groups of accessories based on values associated with one or more of the compatibility of accessories in logical groups, the type of accessories in logical groups, and the features of accessories in the logical groups.

11. The system of claim 9, further comprising logic for generating a signature for each of the accessories based on one or more of the compatibility of the accessory, the type of the accessory, the features of the accessory, a title of the accessory, and a description of the accessory.

12. The system of claim 11, further comprising logic for classifying the accessories into logical groups based on the signatures associated therewith.

13. A computer-implemented method, comprising:
obtaining information about accessories;
parsing out individual offers corresponding to the accessories;
extracting meaningful phrases from the offers;
classifying new offers based on the phrases; and
outputting a result of the classification.

14. The method of claim 13, further comprising extracting compatible categories, vendors, families or models from the accessory offers and providing a navigation into offer groups sharing the same compatibility.

15. A computer-implemented training process, comprising:
obtaining accessory offers;
parsing the offers to extract information about the accessories described in the offers;
determining compatibility information from the extracted information about the accessories;
extracting phrases from the extracted information about the accessories;
clustering the extracted phrases;
generating type graphs, receiving user input for manually editing the type graphs;
generating type rules;
classifying the offers into particular accessory types based on the type rules;
identifying features for the accessory types;
generating parsers for feature extraction;
extracting features from offers classified into the particular accessory types; and
clustering the offers into offer groups based on compatibility, corresponding accessory types, and extracted features.

16. A computer-implemented production process, comprising:
obtaining one or more accessory offers;
parsing the one or more accessory offers to extract information about the accessories;
determining compatibility information from the extracted information;
extracting phrases from the information about the accessories;
using the extracted phrases to classify the offers based on type rule definitions;
extracting features from the offers classified into accessory types; and
generating an offer signature based on one or more of compatibility, accessory types, and accessory features associated with the input accessory offer.

17. The process of claim 16, further comprising classifying at least some of the offers into a pre-existing set of offer groups based on the signature of each of the at least some of the offers.

18. The process of claim 16, further comprising classifying at least one of the offers into a new offer group if it cannot be classified into a set of pre-existing offer groups based on the signature of the at least one offer.
